(19) United States
(12) Patent Application Publication
(10) Pub. No.: US 2006/0181833 A1
(43) Pub. Date: Aug. 17, 2006

(54) Surge protection circuit

(76) Inventors: Kenneth J. Brown, Chula Vista, CA (US); Pieter Loftus, San Diego, CA (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/059,443

(22) Filed: Feb. 17, 2005

(51) Int. Cl. H02H 1/00

(52) U.S. Cl. 361/124

(57) ABSTRACT

A surge protector with at least one surge suppressor integrated circuit (IC) having first and second transient voltage suppression (TVS) diodes configured 2 per package for reducing near and far end cross talk in a high speed telecommunication line, and first and second general purpose fuses coupled to said first and second TVS diodes for reducing insertion and return loss in the high speed telecommunication line.

This application claims the benefit of the filing date of a provisional application having Ser. No. 60/457,874 which was filed on Feb. 26, 2004.

### BACKGROUND OF THE INVENTION

A typical data communication system includes data communication equipment that transmits data over a channel provided by a transmission media such as a cable. The channel may be subjected to transient over-voltage conditions which may not only impair the data but also may damage the data communication equipment. A surge protector may be applied across the channel in an attempt to protect the system from such over-voltage conditions. However, the insertion of a surge protector in a channel or cable may introduce various types of signal loss and crosstalk. For example, insertion loss results from the insertion of the surge protector and is expressed as the reciprocal of the ratio of the signal power delivered to that part of the cable or line following the device to the signal power delivered to that same part before insertion of the device. Return loss is a measure of signal reflections occurring along a cable and is caused by various electrical mismatches along the cabling of the channel.

In addition, transmission of data over a data channel may introduce crosstalk which is a signal disturbance, such as noise or interference, caused by electromagnetic coupling from one signal path to another. Crosstalk measured at the end from which the disturbing signal is transmitted is referred to as near end cross talk (NEXT). Crosstalk measured at the opposite end from which the disturbing signal is transmitted is referred to as far end cross talk (FEXT). The Telecommunications Industry Association/Electronic Industry Association (TIA/EIA) provides specifications and compliance requirements for cabling used in data communication systems operating at different data rates. For example, category 5 specifies requirements for a system communicating up to 100 Mbps (Fast Ethernet) and category 5e (enhanced) specifies data rates up to 1 Gbps.

What is needed is a category 5e surge protector that provides transient protection while meeting industry standards such as signal loss and crosstalk for a communication cabling system.

### SUMMARY OF THE INVENTION

The present invention overcomes the disadvantages of the prior art by providing a surge protector having transient protection that meets industry standards for signal loss and crosstalk specifications for a category 5e cabling system.

In one embodiment, a surge protector is provided that includes at least one surge suppressor integrated circuit (IC) having first and second transient voltage suppression (TVS) diodes configured 2 per package for reducing crosstalk such as NEXT and FEXT in a high speed telecommunication line. A first and second general purpose (e.g., non-telecommunication grade) fuse is coupled to the first and second TVS diodes for reducing signal loss such as insertion and return loss in the high speed telecommunication line. This configuration substantially meets category 5e industry standards for signal loss and crosstalk.

The foregoing has outlined the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 is a schematic diagram of a surge protector according to one embodiment of the present invention;

FIG. 2 is a top view of a surge suppressor IC of FIG. 1;

FIG. 3 is a pin layout of the surge suppressor IC of FIG. 2;

FIG. 4 is a schematic diagram of the surge suppressor IC of FIG. 2; and

FIG. 5 is a PCB layout of the surge protector of FIG. 1.

### DETAILED DESCRIPTION

The present invention discloses a surge protector that provides transient protection and substantially meets category 5e industry standards for signal loss and crosstalk. The surge protector includes at least one surge suppressor integrated circuit (IC) having first and second transient voltage suppression (TVS) diodes configured 2 per package for reducing crosstalk such as near end cross talk (NEXT) and far end cross talk (FEXT) for a category 5e high speed telecommunication line. A first and second general purpose fuse (e.g., non-telecommunication grade) is coupled to the first and second TVS diodes for reducing signal loss such as insertion and return loss for a category 5e high speed telecommunication line. Moreover, the TVS diodes can help provide transient protection by diverting an input overvoltage condition to the TVS diodes and away from computer/electrical devices.

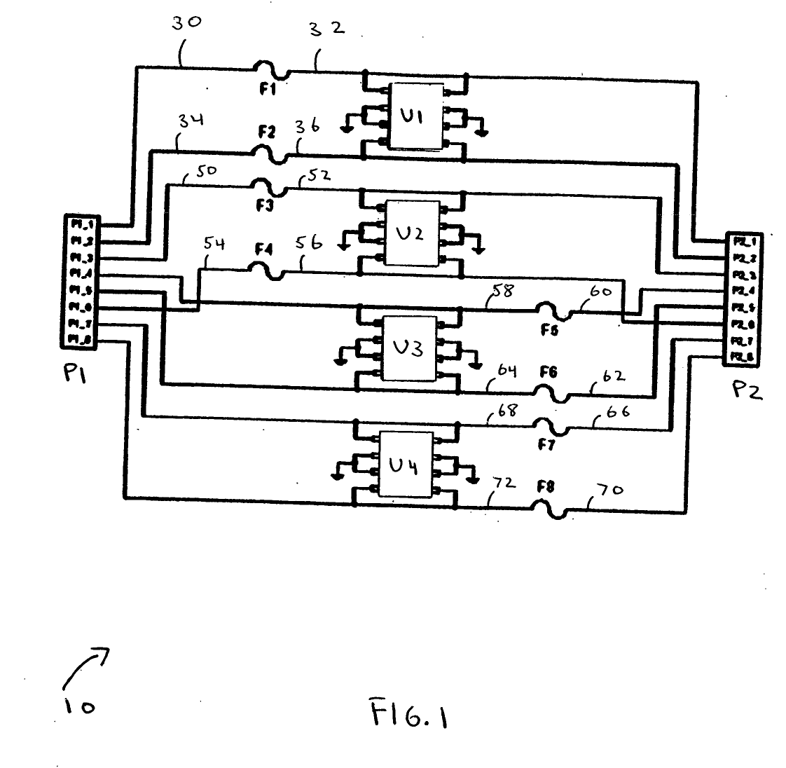

Referring to FIG. 1, shown is a a schematic diagram of a surge protector 10 according to an embodiment of the present invention. The surge protector 10 includes surge suppressor ICs U1, U2, U3 and U4 which can be grouped or configured into packages where each package contains a pair of ICs and corresponding fuses. For example, U1 and U2 can be configured to form one package and U3 and U4 can be configured to form another package. This arrangement can help reduce crosstalk such as FEXT and NEXT. In particular, the arrangement of the surge protector 10 substantially meets the energy handling capability of the UL497B standard for transient protection and the category 5e channel cabling requirements for high speed transmission lines.

In one application, surge protector 10 can be disposed between a transmitting computer/electrical device (not shown) via a first connector P1 and a receiving device (not shown) via a second connector P2. The terminals P1_1 through P1_8 of connector P1 and the terminals P2_1 through P2_8 of connector P2 can be arranged into 4 signal line pairs where each signal line pair is associated with a surge suppressor IC and a pair of fuses. The first signal line pair includes a first signal line defined by terminals P1_1, P2_1, conductors 30, 32 and fuse F1 and a second signal line defined by terminals P1_2, P2_2, conductors 34, 36 and fuse F2. The second signal line pair includes a third signal line defined by terminals P1_3, P2_3, conductors 50, 52 and fuse F3 and a fourth signal line defined by terminals P1_6, P2_6, conductors 54, 56 and fuse F4. The third signal line pair includes a fifth signal line defined by terminals P1_4, P2_4, conductors 58, 60 and fuse F5 and a sixth signal line defined by terminals P1_5, P2_5, conductors 62, 64 and fuse F6. The fourth signal line pair includes a seventh signal line defined by terminals P1_7, P2_7, conductors 66, 68 and fuse F7 and an eighth signal line defined by terminals P1_8, P2_8, conductors 70, 72 and fuse F8.

In one embodiment, connectors P1, P2 are category 5e compliant connectors such as series S164 8-pin registered jacks (RJ)-45 jacks manufactured by Stewart Inc. for use in high speed (1 Gbps) Ethernet data communication or telecommunication applications. It should be understood that the invention can be applied to other connector configurations and other transmission line speeds. Fuses F1 through F8 can be implemented as 8 in-line, 3 amperes, 250 VAC surface mount device (SMD) current limiting general purpose fuses (non-telecommunication) such as those manufactured by Littlefuse Inc.

Surge suppressor circuits U1, U2, U3 and U4 provide transient protection for each of the 4 signal pairs. In particular, surge suppressor U1 provides transient protection for the first signal pair, U2 provides transient protection for the second signal pair, U3 provides transient protection for the third signal pair and U4 provides transient protection for the fourth signal pair. A description of only suppressor U1 is provided below since the functionality of suppressors U2, U3 and U4 is similar to suppressor U1.

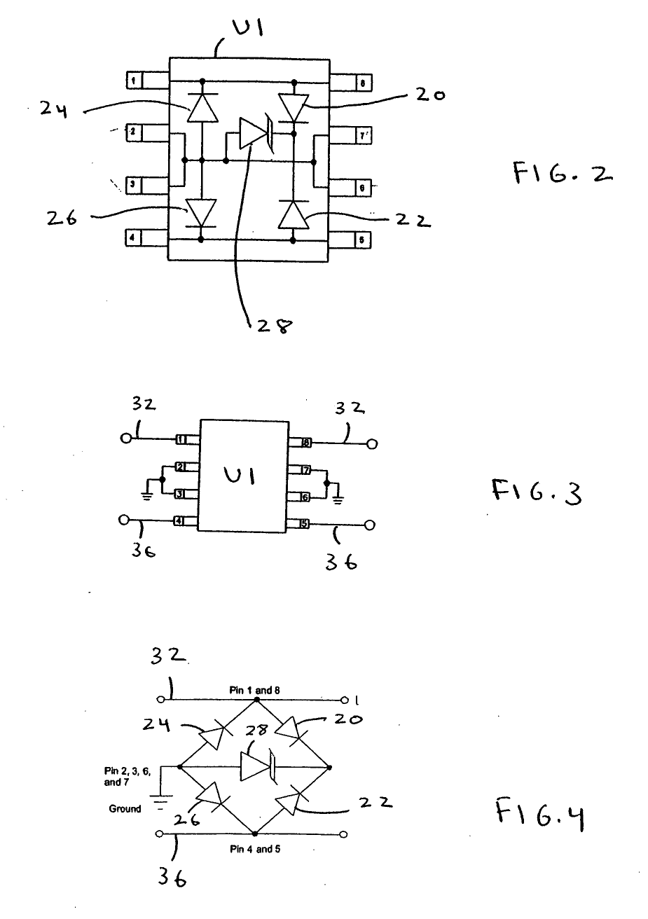

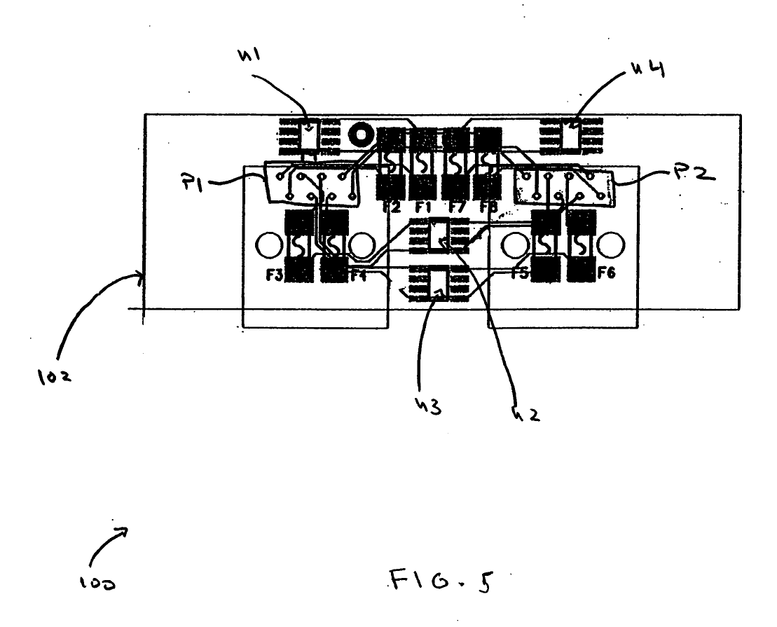

Referring to FIGS. 2 through 4, shown is a detailed view of surge suppressor U1 of the surge protector of FIG. 1. In one embodiment, U1 (as well as U2, U3 and U4) is a microcircuit or IC for protecting components connected to high speed telecommunication lines (category 5e) from surges. An example of such a circuit is the model LC03-6 low capacitance TVS device for high speed data interfaces manufactured by Semtech Corporation. The capacitance of the device, which is less than 25 Picofarads for the transmission of signals greater than 100 Megahertz, can be within a range of 10 to 60 Picofarads for signals of between 80 to 500 Megahertz. Such characteristics help the surge protector meet category 5e requirements.

Surge suppressor U1 is shown configured for differential (line to line) protection. Surge suppressor U1 includes a diode bridge comprising four diodes 20, 22, 24, 26 and a TVS diode 28 coupled across the bridge. The cathode of diode 24 and the anode of diode 20 are connected to conductor 32 via pins 1, 8. Similarly, the cathode of diode 26 and the anode of diode 22 are connected to conductor 36 via pins 4, 5. The anode of diodes 24, 26 and TVS diode 28 are to a common ground terminal via pins 2, 3 and 6, 7. The cathode of diodes 20, 22 and TVS diode 28 are connected together internally.

Referring to FIGS. 1-4, suppressor circuit U1 is capable of providing, overvoltage protection for the first signal pair comprising first and second signal lines. During an overvoltage condition on the first signal line, an undesirable positive transient having a magnitude greater than the breakover point of TVS diode 28 and less than the current level of fuse F1 flows through terminal P1_1, conductor 30, fuse F1, conductor 32, diode 20 and TVS diode 28. TVS diode 28 conducts and passes the transient to the ground terminal thereby shunting the transient current away from a receiving electrical device at terminal P2_1. In a similar manner, a positive transient on the second signal line having a magnitude greater than the breakover point of TVS diode 28 and less than the current level of fuse F2 conducts through terminal P1_2, conductor 34, fuse F2, conductor 36, of diode 22 and TVS diode 28. TVS diode 28 conducts and passes the transient to the ground terminal thereby shunting the excess transient away from an electrical device at terminal P2_2. On the other hand, during normal operation (a non-overvoltage condition), a non-transient signal flows across terminals P1_1, P2_1 (or P1_2, P2_2) without being shunted to ground because the signal is not of a sufficient magnitude to cause TVS diode 28 to conduct.

FIG. 5 is a printed circuit board (PCB) layout 100 of the surge protector 10 of FIG. 1 according to an embodiment of the present invention. The components of the surge protector 10 can be configured to form 2 packages with each package consisting of 2 groups of ICs and corresponding fuses. For example, the first package can consist of a first group consisting of U1 and a parallel arrangement (i.e., side by side) of fuses F1 and F2 and a second group of consisting of U2 and a parallel arrangement of fuses F3 and F4. The second package can consist of a third group consisting of U3 and a parallel arrangement of fuses F5 and F6 and a forth group consisting of U4 and a parallel arrangement of fuses F7 and F8. In addition, each group of each package can be configured as a transmission channel, receive channel or a bidirectional channel. For example, the first group (U1) can be configured as a first transmission channel and the second group (U2) can be configured as a first receive channel. Likewise the third group (U3) can be configured as a second transmission channel and the fourth group (U4) can be configured as a second receive channel. The above configuration helps reduce both NEXT and FEXT to achieve category 5e requirements.

Other configurations having a similar functionality as the above configuration are possible. For example, the second group (U2) can be configured as a first transmission channel and the third group (U3) can be configured as a first receive channel. Likewise, the first group (U1) can be configured as a second transmission channel and the fourth group (U4) can be configured as a second receive channel.

While there have been shown and described and pointed out the fundamental novel features of the invention as applied to the preferred embodiments, it will be understood that various omissions and substitutions and changes of the form and details of the structures and circuits illustrated and in their operation may be made by those skilled in the art without departing from the spirit of the invention.

What is claimed is:

1. A surge protector comprising:
at least one surge suppressor integrated circuit (IC) having first and second transient voltage suppression (TVS) diodes configured 2 per package, first and second general purpose fuses coupled to said first and second TVS diodes, wherein the first and second fuses of a package are positioned adjacent to each other.

2. The surge protector of claim 1, wherein the first fuse and/or the second fuse have a current limit of substantially 3 amperes.

3. The surge protector of claim 1, wherein the at least one surge supressor IC has a capacitance of substantially 25 Picofarads.

4. The surge protector of claim 1, wherein the surge protector substantially meets category 5e cabling requirements.

5. A surge protector comprising:
at least one surge suppressor integrated circuit (IC) having first and second transient voltage suppression (TVS) diodes configured 2 per package for reducing near and far end cross talk in a high speed telecommunication line, and first and second general purpose fuses coupled to said first and second TVS diodes for reducing insertion and return loss in the high speed telecommunication line wherein said first and second fuses are not telecommunication fuses.

6. The surge protector of claim 5, wherein the first fuse and/or the second fuse have a current limit of substantially 3 amperes.

7. The surge protector of claim 5, wherein the at least one surge suppressor IC has a capacitance of substantially 25 Picofarads.

8. The surge protector of claim 5, wherein the surge protector substantially meets category 5e cabling requirements.

9. A surge protector comprising:
at least four surge suppressor integrated circuits (ICs) having first and second transient voltage suppression (TVS) diodes configured 2 per package for reducing near and far end cross talk in a high speed telecommunication line, and first and second general purpose fuses coupled to each of said ICs for reducing insertion and return loss in the high speed telecommunication line wherein said first and second fuses are not telecommunication dedicated fuses and at least two of said fuses are positioned side by side on a printed circuit board.

10. The surge protector of claim 9, wherein the first fuse and/or the second fuse have a current limit of substantially 3 amperes.

11. The surge protector of claim 9, wherein each of the at least four surge suppressor ICs has a capacitance of substantially 25 Picofarads.

12. The surge protector of claim 9, wherein the surge protector substantially meets category 5e cabling requirements.
